(19) United States
(12) Patent Application Publication
(10) Pub. No.: US 2025/0211003 A1
(43) Pub. Date: Jun. 26, 2025

(54) RESETTABLE OVER CURRENT PROTECTION CIRCUITRY

(71) Applicant: VOLVO TRUCK CORPORATION, Göteborg (SE)

(72) Inventors: Tomas THELIN, Kärna (SE); Diego Santos Pereira NETTO, Askim (SE); Emil LIDSTROM, Torslanda (SE)

(73) Assignee: VOLVO TRUCK CORPORATION, Göteborg (SE)

(21) Appl. No.: 18/977,171

(22) Filed: Dec. 11, 2024

(30) Foreign Application Priority Data
Dec. 22, 2023 (EP) 23219706.1

(51) Int. Cl. H02J 7/00

(52) U.S. Cl. CPC H02J 7/00304; H02J 7/0031; H02J 7/0036; H02J 7/0045; H02J 2310/48

(57) ABSTRACT

A resettable over current protection circuitry for an energy storage system of a vehicle is presented. The resettable over current protection circuitry is configured to be arranged between one or more battery cells and a load and comprises a transistor device configured for controlling an electrical connection between the battery cell and the load. The resettable over current protection circuitry further comprises current sensor circuitry for measuring a load current between the one or more battery cells and the load and control circuitry configured to control the transistor device to break the electrical connection between the one or more battery cells and the load responsive to the load current being above a first predetermined threshold during a first predetermined time.

### TECHNICAL FIELD

The disclosure relates generally to over current protection. In particular aspects, the disclosure relates to resettable over current protection circuitry. The disclosure can be applied to vehicles in general, nautical vehicles, heavy-duty vehicles, such as trucks, buses, and construction equipment, among other vehicle types. Although the disclosure may be described with respect to a particular vehicle, the disclosure is not restricted to any particular vehicle.

### BACKGROUND

Electric vehicles (EVs) are becoming increasingly popular. EVs comprise high voltage system for propelling the vehicle. These high voltage systems generally operate at voltages between 300 and 800 volts which is provided by high energy EV batteries. These voltages are significantly higher than voltages used in conventional gasoline-powered vehicles. These high voltage and energies poses a risk of excess heating and damages to adjacent and connected components and devices.

### SUMMARY

According to a first aspect of the disclosure, a resettable over current protection circuitry for an energy storage system of a vehicle is presented. The resettable over current protection circuitry is configured to be arranged between one or more battery cells and a load and comprises a transistor device configured for controlling an electrical connection between the battery cell and the load, current sensor circuitry for measuring a load current between the one or more battery cells and the load, control circuitry configured to control the transistor device to break the electrical connection between the one or more battery cells and the load responsive to the load current being above a first predetermined threshold during a first predetermined time. The first aspect of the disclosure may seek to reduce a risk of issues with over current in a vehicle. A technical benefit may include increase of safety, reliability and/or operability of a vehicle.

Optionally in some examples, including in at least one preferred example, the current sensor circuitry comprises a comparator configured to generate a control signal configured to control the transistor device to break the electrical connection between the one or more battery cells and the load. A technical benefit may include having a hardware solution that is fast, reliable and consumes low current.

Optionally in some examples, including in at least one preferred example, the control circuitry is further configured to close the electrical connection between the one or more battery cells and the load responsive to the load current being below a predetermined second threshold during a second predetermined time. A technical benefit may include enabling reactivation and further operation without undue downtime.

Optionally in some examples, including in at least one preferred example, the control circuitry is configured to close the electrical connection between the one or more battery cells and the load responsive to receiving a reset signal. A technical benefit may include allowing external reset to externally override and reset the resettable over current protection circuitry

Optionally in some examples, including in at least one preferred example, the current sensor circuitry comprises a known resistance arranged between the one or more battery cells and the load, and the current sensor circuitry is configured to measure the load current by measuring a voltage drop across the known resistance. A technical benefit may include a low cost solution for acquiring the load current.

Optionally in some examples, including in at least one preferred example, the known resistance is an on-resistance of the transistor device. A technical benefit may include not having to provide a high cost high accuracy resistor in the current path.

Optionally in some examples, including in at least one preferred example, the first predetermined time is determined by a time constant of hardware components of the control circuitry. A technical benefit may include having a hardware solution that is fast, reliable and consumes low current.

Optionally in some examples, including in at least one preferred example, the control circuitry is configured to control the transistor device to limit the electrical connection between the battery cell and the load responsive to the load current being above a third predetermined threshold during a third predetermined time. A technical benefit may include allowing continued operation of the vehicle even if the load current is above a threshold.

Optionally in some examples, including in at least one preferred example, the resettable over current protection circuitry further comprising an internal power source arranged to power the resettable over current protection circuitry. A technical benefit may include allowing the resettable over current protection circuitry to function without draining an external power source and to in absence of an external power source.

Optionally in some examples, including in at least one preferred example, the current sensor circuitry comprises a comparator configured to generate a control signal configured to control the transistor device to break the electrical connection between the one or more battery cells and the load; the control circuitry is further configured to close the electrical connection between the one or more battery cells and the load responsive to the load current being below a predetermined second threshold during a second predetermined time; the control circuitry is configured to close the electrical connection between the one or more battery cells and the load responsive to receiving a reset signal; wherein the current sensor circuitry comprises a known resistance arranged between the one or more battery cells and the load, and the current sensor circuitry is configured to measure the load current by measuring a voltage drop across the known resistance; the known resistance is an on-resistance of the transistor device; the first predetermined time is determined by a time constant of hardware components of the control circuitry; the control circuitry is configured to control the transistor device to limit the electrical connection between the battery cell and the load responsive to the load current being above a third predetermined threshold during a third predetermined time; and further comprising an internal power source arranged to power the resettable over current protection circuitry wherein the internal power source is a rechargeable power source arranged to be charged from the battery cell. A technical benefit may include all of the above benefits and also reduced environmental impact and simplicity of use as the internal power source is not required.

According to a second aspect of the disclosure, battery pack comprising one or more battery cells, at least two terminals for connecting the battery pack to a load and the resettable over current protection circuitry of the first aspect arranged in a current path of the one or more battery cells and the at least two terminals is presented. The second aspect of the disclosure may seek to reduce a risk of issues with over current in a vehicle. A technical benefit may include increase of safety, reliability and/or operability of a vehicle.

According to a third aspect of the disclosure, an energy storage system, comprising at least one battery pack of the second aspect and an energy storage processing circuitry operatively connected to and configured to control the control circuitry of the resettable over current protection circuitry of the battery pack. The third aspect of the disclosure may seek to reduce a risk of issues with over current in a vehicle. A technical benefit may include increase of safety, reliability and/or operability of a vehicle.

Optionally in some examples, including in at least one preferred example, the energy storage system processing circuitry is configured to cause control of the transistor device to provide a pre-charge current to the load. A technical benefit may include a reduced cost of the energy storage system and/or battery pack as the spacious and expensive pre-charge resistor is no longer required. Also, the pre-charge current may be adaptive and is not set by the fixed pre-charge transistor.

Optionally in some examples, including in at least one preferred example, the energy storage system processing circuitry is further configured to cause control of at least one electromechanical connector arranged to selectively connect the at least one battery pack to the load, and prior to causing the electromechanical connector to disconnect the at least one battery pack from the load, control the transistor device to break the electrical connection between the battery cell and the load and/or wherein the energy storage system processing circuitry is configured to, prior to causing the electromechanical connector to connect the at least one battery pack to the load, control the transistor device to break the electrical connection between the battery cell and the load. A technical benefit may include reducing wear of the electromechanical connector.

According to a fourth aspect of the disclosure, a vehicle comprising the energy storage system of the third aspect is presented. The fourth aspect of the disclosure may seek to reduce a risk of issues with over current in a vehicle. A technical benefit may include increase of safety, reliability and/or operability of a vehicle.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is a side view of an exemplary vehicle according to an example.

FIG. 2 is a block diagram of an exemplary vehicle according to an example.

FIG. 3A is a block diagram of an exemplary resettable over current protection circuitry according to an example.

FIG. 3B is a block diagram of an exemplary resettable over current protection circuitry according to an example.

FIG. 4A is an exemplary time series plot according to an example.

FIG. 4B is an exemplary schematic of a control circuitry according to an example.

FIG. 5A is an exemplary time series plot according to an example.

FIG. 5B is an exemplary schematic of a control circuitry according to an example.

FIG. 6A is an exemplary time series plot according to an example.

FIG. 6B is an exemplary schematic of a control circuitry according to an example.

FIG. 7 is an exemplary time series plot according to an example.

FIG. 8 is an exemplary block diagram of an energy storage system according to an example.

FIG. 9 is a block diagram of an exemplary battery pack according to an example.

### DETAILED DESCRIPTION

The detailed description set forth below provides information and examples of the disclosed technology with sufficient detail to enable those skilled in the art to practice the disclosure.

As indicated, high voltage systems of electrical vehicles (EVs) require control, maintenance and security measures in place in order to ensure safe operation of the EV. For instance, even when an EV is turned off, there may still be high voltage present in the system. This is because batteries and capacitive loads of the EV still retain charge. EV batteries contain a lot of energy, and if they are short-circuited, damaged or overheated, they can cause hazardous situations.

In order to ensure safety of persons inside, or at a vicinity of a vehicle, numerous safety measures are generally in place such as automatic high voltage disconnect (AHVD) systems. The AHVD system will disconnect the battery from the rest of the vehicle in the event of an accident or other emergency. AHVD systems can be triggered by a variety of events, such as vehicle collisions, rollover accidents, fire, electrical problems, overheating, software glitches etc. Some AHVD systems can also be triggered manually, using a switch or button located in the vehicle. This can be useful for first responders who need to disconnect the battery pack before working on a damaged EV. Once triggered, the AHVD system generally requires professional service of the vehicle in order to be reset.

Further to the AHVD systems, electrical current paths of vehicles are generally provided with fuses configured to break in case of over currents. An issue with such fuses are that they are generally one-shots and once triggered, they have to be replaced. Such overcurrent protection fuses generally works by melting a metal strip when too much current flows through it.

The present disclosure will present a resettable over current protection circuitry that allows an over current protection circuitry to be reset in case of a temporary overcurrent. The teachings of the present disclosure may be implemented on a single battery cell, a group of battery cells (connected in series and/or parallel), one or more battery packs and/or any other part of an electric power system where over current protection is considered. This is advantageous in situations wherein for instance one battery pack of a plurality of battery packs experiences a temporary over current as although the over current protection circuitry triggers and disconnect the concerned battery pack, the other battery packs may continue to provide power to a load avoiding disruption or stops in operation. The resettable over current protection circuitry may, as the name suggests, be reset without having to replace a broken fuse or mechanically toggle a switch.

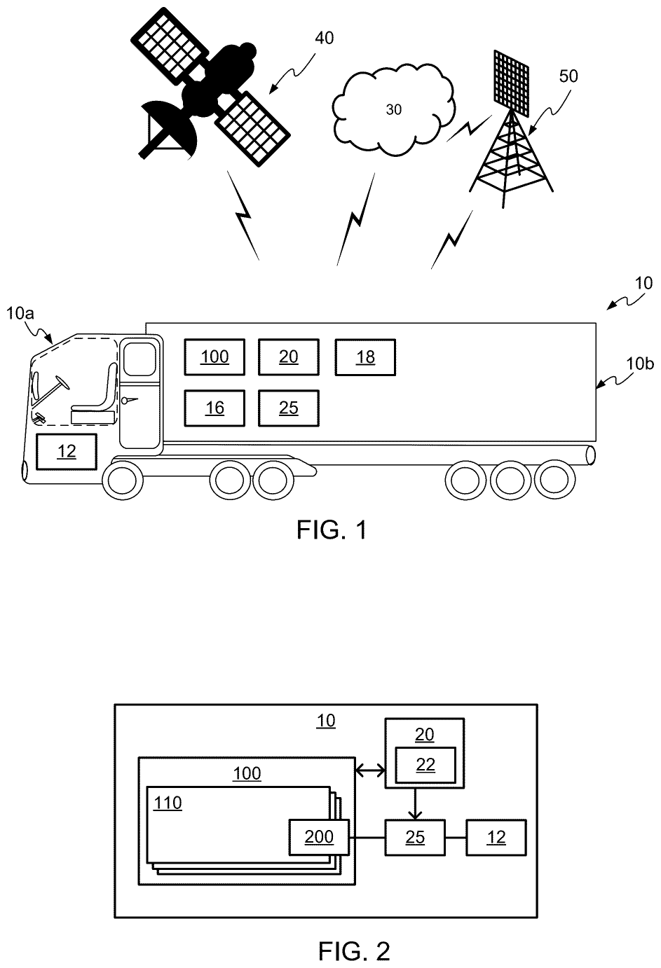

Although the resettable over current protection circuitry of the present disclosure may be applied to any electric circuitry, examples and embodiments will be given mainly in reference to a vehicle 10, sec FIG. 1. FIG. 1 is an exemplary schematic side view of a heavy-duty vehicle 10 (hereinafter referred to as vehicle 10). The vehicle 10 comprises a tractor unit 10a which is arranged to tow a trailer unit 10b. In other examples, other vehicles may be employed, e.g., trucks, buses, nautical vehicles and construction equipment. The vehicle 10 comprises all vehicle units and associated functionality to operate as expected, such as a powertrain, chassis, and various control systems. The vehicle 10 comprises one or more propulsion sources 12. The propulsion source 12 may be any suitable propulsion source 12 exemplified by, but not limited to, one or more or a combination of an electrical motor, a combustion engine such as a diesel, gas or gasoline powered engine. The vehicle 10 further comprises an energy source 100 suitable for providing energy for the propulsion source 12. That is to say, if the propulsion source 12 is an electrical motor, a suitable energy source 100 would be a battery or a fuel cell. The vehicle 10 further comprises sensor circuitry 16 arranged to detect, measure, sense or otherwise obtain data relevant for operation of the vehicle 10. The sensor circuit 16 may comprise one or more of a voltmeter, a current meter, an accelerometer, a gyroscope, a wheel Speed Sensor, an ABS sensor, a throttle position sensor, a fuel level sensor, a temperature Sensor, a pressure sensor, a rain sensor, a light sensor, proximity sensor, a lane departure warning sensor, a blind spot detection sensor, a TPMS sensor etc. Operational data relevant for operation of the vehicle 10 may include, but is not limited to, one or more of a speed of the vehicle 10, a weight of the vehicle 10, an inclination of the vehicle 10, a status of the energy source 100 of the vehicle 10 (state of charge, fuel level etc.), a current speed limit of a current road travelled by the vehicle 10, etc. The vehicle 10 may further comprise communications circuitry 18 configured to receive and/or send communication. The communications circuitry 18 may be configured to enable the vehicle 10 to communicate with one or more external devices or systems such as a cloud server 30. The communication with the external devices or systems may be directly or via a communications interface such as a cellular communications interface 50, such as a radio base station. The cloud server 30 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 18 may, additionally or alternatively, be configured to enable the vehicle 10 to be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 40 to determine a geographical location of the vehicle 10.

The exemplary vehicle 10 of FIG. 1 is an electrical vehicle (EV) which is to mean a vehicle 10 at least partially propellable by an electrical propulsion source 12, preferably an electrical motor 12. The electrical motor 12 is powered by one or more battery packs 100. The vehicle 10 further comprise a energy storage system 20, sometimes referred to as a battery management system 20. The energy storage system 20 is configured to monitor and/or control operation of the one or more battery packs 100. The vehicle 10 further comprise an electromechanical connector 25 arranged to selectively connect the battery pack 100 to the electrical motor 12, i.e. the load 12.

In FIG. 2, a partial block diagram of a vehicle 10 according to the present disclosure is shown. The vehicle 10 comprises a battery pack 100, an optional electromechanical connector 25, a load 12 in the form of an electrical motor 12, and an energy storage system 20. The electromechanical connector 25 is arranged to control an electrical connection between the load 12 and the battery pack 100. The energy storage system 20 is operatively connected to the battery pack 100 and is arranged to control the optional electromechanical connector 25. To this end, the energy storage system 20 comprises energy storage system processing circuitry 22.

Generally, the electromechanical connector 25 (if present) is provided to allow a controlled disconnect of the battery pack 100 prior to service, replacement or other maintenance of the battery pack 100 and/or vehicle 10. An electromechanical connector 25 is to mean any connector that galvanically breaks a current path responsive to electrical controls. One example of an electromechanical connector 25 may be a relay. In some examples, the electromechanical connector 25 may be a motorized connector controllable to move e.g. a connecter in and out of galvanic contact with poles of a battery pack 100.

The battery pack 100 in FIG. 2 comprise a plurality of battery cells 110. This is one example, and in other examples, the battery pack 100 comprise only one battery cell 110. The battery cells 110 may be connected in series to allow the battery pack 100 to provide a voltage higher than a voltage of each of the battery cells 110. The battery cells 110 may be connected in parallel to allow the battery pack 100 to provide a capacitance that is higher than a capacitance of each of the battery cells 110. In some examples, the battery pack 100 comprises a plurality of sets of battery cells 110. Battery cells 110 of each set of battery cells are connected in series and the sets of battery cells are connected in parallel to provide both an increased voltage and capacitance from the battery pack 100 compared to what is offer by a single battery cell 110. Regardless of how the battery cells 110 are connected, the battery pack 100 may comprise one or more resettable over current protection circuitry 200. The one or more resettable over current protection circuitry 200 may be connected in any current path of the battery pack 100. In the following, the resettable over current protection circuitry 200 will be described as arranged in a current path between the battery cells 110 of the battery pack 100 and the load 12. However, other arrangements of the resettable over current protection circuitry 200 will be directly derivable form the present disclosure even if they are not explicitly mentioned.

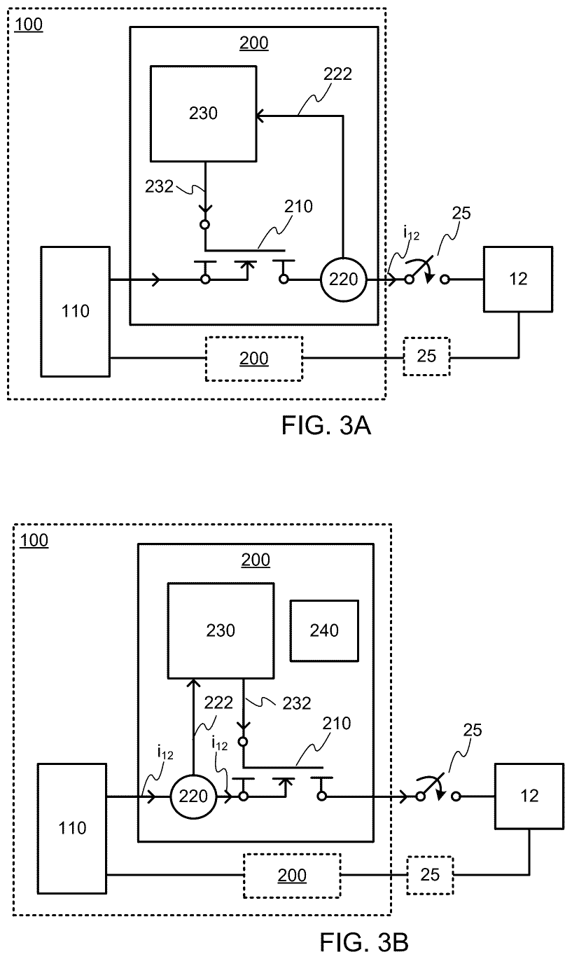

In FIG. 3A and FIG. 3B, block diagrams of exemplary resettable over current protection circuitry 200 connected in series between one or more battery cells 110 and a load 12 are shown. The resettable over current protection circuitry 200 comprises a transistor device 210, sensor circuitry 220 and control circuitry 230.

The transistor device 210 is arranged to control an electrical connection between the battery cell 110 and the load 12. The transistor device 210 may be any suitable transistor device 210 exemplified by, but not limited to, a bipolar junction transistor (BJT), a field-effect transistor (FET) (e.g. junction FET, metal-oxide-semiconductor FET, metal-semiconductor FET), an insulated gate bipolar transistors (IGBT), a heterojunction bipolar transistor (HBT), etc. The selection of the particular type of transistor device 210 will generally depend on design parameters such as expected current handling capabilities (continuous current, breakable current etc.), voltage handling capabilities, switching speed etc.

The sensor circuitry 220 is configured to obtain a load current i₁₂, i.e. a current into the load 12 or into (in case of charging) the battery cell 110. The sensor circuitry 220 may form part of, or be operatively connected to, the previously mentioned sensor circuit 16 of the vehicle 10. The sensor circuit 220 may comprise any suitable circuitry to estimate, measure, determine or otherwise obtain the load current load current i₁₂. In some examples, the sensor circuitry 220 comprises circuitry for indirect measurement of the load current i₁₂ such as a known resistance connected in series in the path of the load current i₁₂ and voltage measuring circuit arranged to obtain a voltage drop actor the known resistance. The load current i₁₂ may in such examples be determined by Ohm's law. In some examples, the sensor circuit comprises circuitry for direct measurement of the load current i₁₂ such as a moving coil ampere meter, a moving magnet ampere meter, an electrodynamic ampere meter, a moving iron ampere meter etc. In some examples, the sensor circuitry 220 comprises circuitry to obtain a voltage drop across the transistor device 210. The voltage drop across the transistor device 210 may be utilized together with a known on-resistance of the transistor device 210 to determine the load current i₁₂ by Ohm's law. The on-resistance may, depending on the type of transistor device, vary with temperature, control current or voltage (a control signal 232), etc. of the transistor device 210 which is known in the art.

The control circuitry 230 is configured to control the transistor device 210. The control circuitry is configured to provide the control signal 232 for control of the transistor device 210 to control the transistor device 210 to conduct, i.e. close the electrical connection between the battery cell 110 and the load 12, or not to conduct, i.e. break the electrical connection between the battery cell 110 and the load 12. The control circuitry 230 is configured to control the transistor device 210 based on the load current i₁₂. To this end, the control circuitry 230 is operatively connected to the sensor circuitry 220 and configured to obtain current data 222 from the sensor circuitry 220. The current data 222 may be any suitable representation of the load current i₁₂, such as a voltage level etc.

In FIG. 3A, the sensor circuitry 220 is arranged between the transistor device 210 and the load 12. In FIG. 3B, the sensor circuitry 220 is arranged between the transistor device 210 and the battery cell 110. In other examples, sensor circuitry may be arranged both between the transistor device 210 and the load 12, and between the transistor device 210 and the battery cell 110. Any of these examples may be combined with sensor circuitry 220 comprising circuitry to obtain a voltage drop across the transistor device 210.

As seen in FIG. 3A and FIG. 3B, resettable over current protection circuitry 200 may be provided in either an output and/or a return current path between the battery cell(s) 110 and the load 12. The optional electromechanical connector 25 may be provided in either an output and/or a return current path between the battery cell(s) 110 and the load 12.

As seen in FIG. 3B, the resettable over current protection circuitry 200 may comprise an internal power source 240. The internal power source 240 is only illustrated in FIG. 3B, but may very well be provided in any other example of the resettable over current protection circuitry 200. The internal power source 240 may be any suitable power source 240 capable of providing power to the resettable over current protection circuitry 200. The internal power source 240 may be one or more of a non-rechargeable battery, a rechargeable battery, a capacitor or a super-capacitor. In case of a rechargeable internal power source 240, the internal power source 240 may be charged from the battery cell 110 and/or any other external charger. The internal power source 240 may be a removable internal power sources 240. The internal power source 240 enables the resettable over current protection circuitry 200 to function even if no external power is available to the resettable over current protection circuitry 200.

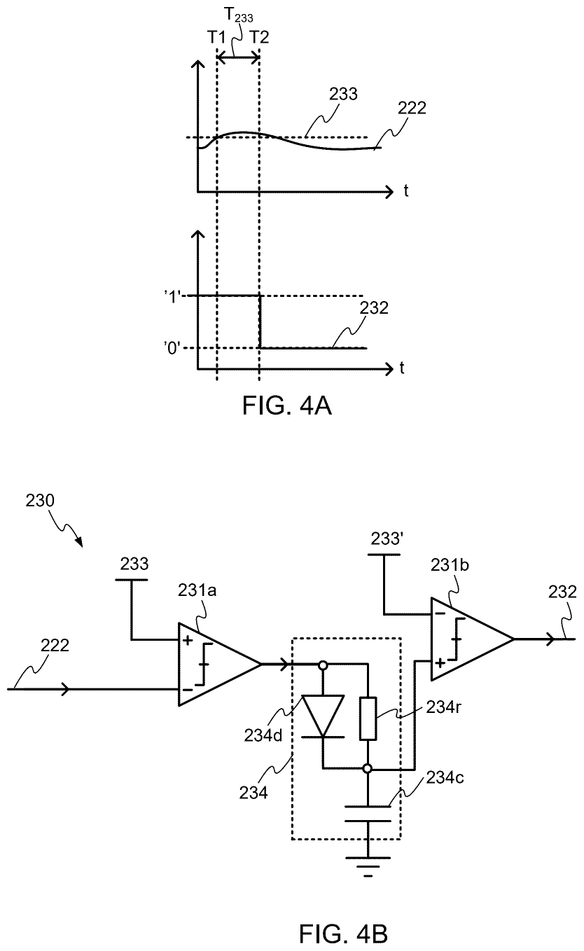

In FIG. 4A, exemplary time signal plots of the control signal 232 (lower graph) and the current data 222 (upper graph) are shown in reference to an aligned a common time axis t. As seen in the upper graph, at a first point in time T1, the current data 222 indicate a value of the load current i₁₂ exceeding a first predetermined threshold 233. However, as seen in the lower graph of FIG. 4A, the control signal 232 remains at an active or high state indicated by ‘1’ in FIG. 4A. It should be noted that the naming of the e.g. the control signal 232 suggests that the transistor device 210 is active (conducting) responsive to a high control signal 232 but this is but one example and adjusting plots, circuitry, examples and embodiments of the present disclosure to be active at a low control signal 232 is, after having digested the teachings of the present disclosure, well within the knowledge of the skilled person. At a second point in time T2, the current data 222 has indicated values of the load current i₁₂ exceeding the first predetermined threshold 233 for a first predetermined time T₂₃₃. It is not until the second point in time T2 that the control signal 232 toggles to an inactive or low state indicated by ‘0’ in FIG. 4A, i.e. breaks the current path between the battery cell 110 and the load 12.

Delaying the deactivation of the transistor device 210 by the first predetermined time T₂₃₃ enables triggering not only based on an absolute over current, or an amount of over energy which is the case with one-shot fuses. A one-shot fuse would generally trigger by breaking a conductor inside the one-shot fuse due to heating of the conductor. The heating of the conductor will depend on an amount of current and a time it takes for a one-shot fuse to trigger will depend on a magnitude of the overcurrent. Further, repeated current peaks above a threshold current may heat the one-shot fuse and cause it to trigger after a time. The delayed activation as presented in FIG. 4A will always trigger after the load current i₁₂ exceeding the first predetermined threshold 233 (or an indication of the load current i₁₂ exceeding the first predetermined threshold 233) for the first predetermined time T₂₃₃, regardless of how much or little or much load current i₁₂ (or the indication of the load current i₁₂) exceeds the first predetermined threshold 233.

The behavior of the control signal 232 indicated with reference to FIG. 4A may be provided by a software implemented run on a control circuitry 230 comprising processing circuitry. However, in order to ensure functionality and reaction speed of the control circuitry 230, the functionality is advantageously implemented mainly in hardware solution.

In FIG. 4B, an exemplary control circuitry 230 is shown. The control circuitry 230 in FIG. 4B is configured to provide the control signal 232 at an active state (high or ‘1’) as long as the current data 222 is below the first predetermined threshold 233. In FIG. 4B, the first predetermined threshold 233 and the current data 222 are voltage levels are voltage levels provided to a first comparator circuitry 231a. The current data 222 is provided at a negative input of the first comparator circuitry 231a and the first predetermined threshold 233 is provided at a positive input of the first comparator circuitry 231a. As long as the current data 222 is below the first predetermined threshold 233, an output of the first comparator circuitry 231a will be set at a high state (active or ‘1’). The output of the first comparator circuitry 231a is connected a positive input of second comparator circuitry 231b via filter circuitry 234. A negative input of the second comparator circuitry 231b is connected to a first intermediate threshold 233′. The control signal 232 is provided at an output of the second comparator circuitry 231b and will be at an active state (high or ‘1’) as long as the output of the filter circuitry 234 is greater than the first intermediate threshold 233′.

In order to control the control signal 232 to be inactive (low or ‘0’) in response to the current data 222 exceeding the first predetermined threshold 233 for the first predetermined time T₂₃₃, the filter circuitry 234 is configured with a time constant such that it takes the first predetermined time T₂₃₃ for an output of the filter circuitry 234 to fall below the first intermediate threshold 233′. In FIG. 4B, filter circuitry 234 comprises a filter resistor 234r connected, at one terminal, to an input of the filter circuitry 234 and at another terminal to one terminal of a filter capacitor 234c of the filter circuitry 234. Another terminal of the filter capacitor is connected to a reference ground. An output of the filter circuitry 234 is provided between the filter resistor 234r and the filter capacitor 234c and, as mentioned, connected to the positive input of the second comparator circuitry 231b. Responsive to the current data 222 exceeding the first predetermined threshold 233, the output of the first comparator circuitry 231a will be set low (‘0’) discharging the filter capacitor 234c via the filter resistor 234r with a time constant determined by a product between a capacitance of the filter capacitor 234c (including any stray capacitance) and a resistance of the filter resistance 234r (including any stray resistance). This will cause a voltage at the output of the filter circuitry 234 to slowly decrease (at least) until it falls below the first intermediate threshold 233′ and the output of the second comparator circuitry 231b will be set low (‘0’) and consequently the control signal 232 will be set at the inactive state (low or ‘0’). In order to ensure that the filter circuitry 234 is reset responsive to the current data 222 no longer exceeding the first predetermined threshold 233 a filter diode 234d may be provided in parallel with the filter resistor 234r arranged to permit a substantially unhindered flow of current into the filter capacitor 234c but forcing a current out from the filter capacitor 234c to flow through the filter resistor 234r.

In the exemplary circuitry shown in FIG. 4B, the first predetermined time T₂₃₃ is determined by the time constant of the filter circuitry 234 and the first intermediate threshold 233′. It may be that the first predetermined time T₂₃₃ is a configurable time. In such examples, the first predetermined time T₂₃₃ may be configured by changing the first intermediate threshold 233′. An increase of the first intermediate threshold 233′ will decrease the first predetermined time T₂₃₃ and a decrease of the first intermediate threshold 233′ will increase the first predetermined time T₂₃₃.

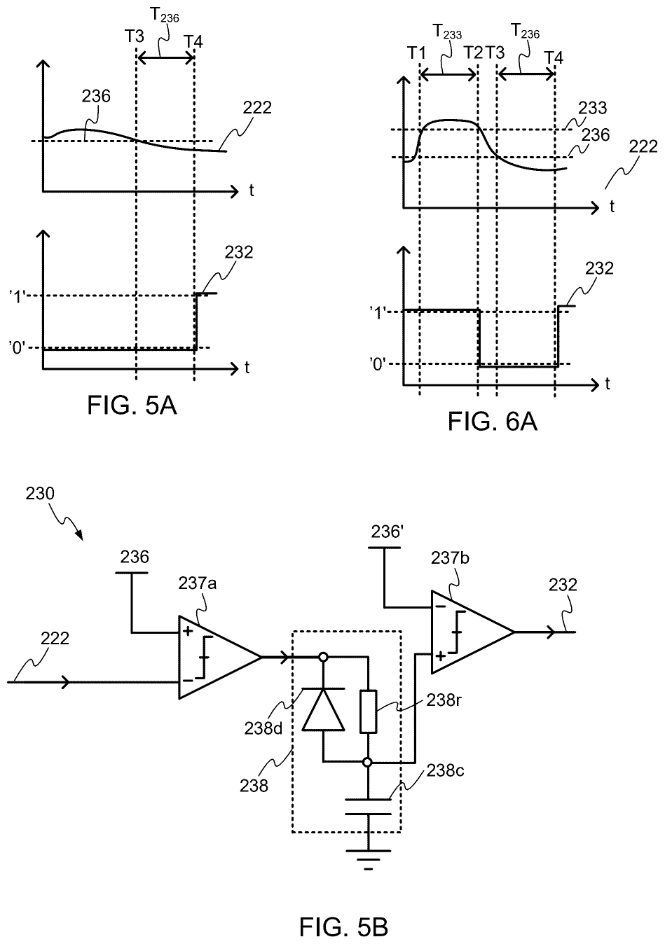

The examples presented with reference to FIG. 4A and FIG. 4B are given in regards to deactivating the transistor device 210, i.e. breaking a current path between the battery cell 110 and the load 12. Optionally, the corresponding features may be provided in relation to activation of the transistor device 210, i.e. closing a current path between the battery cell 110 and the load 12. This enables the over current protection circuitry to be automatically reset in the absence of an overcurrent. In FIG. 5A, exemplary time signal plots of the control signal 232 (lower graph) and the current data 222 (upper graph) are shown in reference to an aligned a common time axis t. As seen in the upper graph, at a third point in time T3, the current data 222 indicate a value of the load current i₁₂ being below a second predetermined threshold 236. However, as seen in the lower graph of FIG. 5A, the control signal 232 remains at an inactive state (low or ‘0’). As in FIG. 4A, in FIG. 5A, the naming of the e.g. the control signal 232 suggests that the transistor device 210 is active (conducting) responsive to a high control signal 232 but this is but one example and adjusting plots, circuitry, examples and embodiments of the present disclosure to be active at a low control signal 232 is, after having digested the teachings of the present disclosure, well within the knowledge of the skilled person. At a fourth point in time T4, the current data 222 has indicated values of the load current i₁₂ being below the second predetermined threshold 236 for a second predetermined time T₂₃₆. It is not until the fourth point in time T4 that the control signal 232 toggles to an active sate (high or ‘1’), i.e. closes the current path between the battery cell 110 and the load 12.

Delaying the activation of the transistor device 210 by the second predetermined time T₂₃₆ introduces hysteresis in the control of the transistor device 210. Adding the second predetermined time T₂₃₆ before an automatic reset of the over current protection circuitry 200 is provided reduces a risk of any temporary faults or issues causing over current remain.

The behavior of the control signal 232 indicated with reference to FIG. 5A may be provided by a software implemented run on a control circuitry 230 comprising processing circuitry. However, in order to ensure functionality and reaction speed of the control circuitry 230, the functionality is advantageously implemented mainly in hardware solution.

In FIG. 5B, an exemplary partial control circuitry 230 is shown. The control circuitry 230 in FIG. 5B is configured to provide the control signal 232 at an active state (high or ‘1’) only after the current data 222 has been below the second predetermined threshold 236 for the second predetermined time T₂₃₆. In FIG. 5B, the second predetermined threshold 236 and the current data 222 are voltage levels are voltage levels provided to a first comparator circuitry 237a. The current data 222 is provided at a negative input of the first comparator circuitry 237a and the second predetermined threshold 233 is provided at a positive input of the first comparator circuitry 237a. As long as the current data 222 is above the second predetermined threshold 236, an output of the first comparator circuitry 237a will be set at a low state (inactive or ‘0’). The output of the first comparator circuitry 237a is connected a positive input of second comparator circuitry 237b via filter circuitry 238. A negative input of the second comparator circuitry 237b is connected to a second intermediate threshold 236′. The control signal 232 is provided at an output of the second comparator circuitry 237b and will be at an inactive state (low or ‘0’) as long as the output of the filter circuitry 238 is below the second intermediate threshold 236′.

In order to control the control signal 232 to be active (high or ‘1’) in response to the current data 222 being below the second predetermined threshold 236 for the second predetermined time T₂₃₆, the filter circuitry 238 is configured with a time constant such that it takes the second predetermined time T₂₃₃ for an output of the filter circuitry 238 to exceed the first intermediate threshold 236′. In FIG. 5B, filter circuitry 238 comprises a filter resistor 238r connected, at one terminal, to an input of the filter circuitry 238 and at another terminal to one terminal of a filter capacitor 238c of the filter circuitry 238. Another terminal of the filter capacitor 238c is connected to a reference ground. An output of the filter circuitry 238 is provided between the filter resistor 238r and the filter capacitor 238c and, as mentioned, connected to the positive input of the second comparator circuitry 237b. Responsive to the current data 222 falling below the second predetermined threshold 236, the output of the first comparator circuitry 237a will be set high (‘1’) charging the filter capacitor 238c via the filter resistor 238r with a time constant determined by a product between a capacitance of the filter capacitor 238c (including any stray capacitance) and a resistance of the filter resistance 238r (including any stray resistance). This will cause a voltage at the output of the filter circuitry 238 to slowly increase at least until it is above the second intermediate threshold 236′ and the output of the second comparator circuitry 237b will be set high (‘1’) and consequently the control signal 232 will be set at the active state (high or ‘1’) state. In order to ensure that the filter circuitry 238 is reset responsive to the current data 222 no longer being below the second predetermined threshold 236, a filter diode 238d may be provided in parallel with the filter resistor 238r arranged to permit a substantially unhindered flow of current out from the filter capacitor 238c but forcing a current into the filter capacitor 238c to flow through the filter resistor 238r.

In the exemplary circuitry shown in FIG. 5B, the second predetermined time T₂₃₆ is determined by the time constant of the filter circuitry 238 and the first intermediate threshold 236′. It may be that the second predetermined time T₂₃₆ is a configurable time. In such examples, the second predetermined time T₂₃₆ may be configured by changing the second intermediate threshold 236′. An increase of the second intermediate threshold 236′ will decrease the second predetermined time T₂₃₆ and a decrease of the second intermediate threshold 236′ will increase the second predetermined time T₂₃₆.

The exemplary circuitry shown in FIG. 4B and FIG. 5B are exemplary circuitry and the present disclosure should not be considered limited to this example. There are numerous different techniques, circuits and features to provide the functionality indicated in FIG. 4A and FIG. 5A.

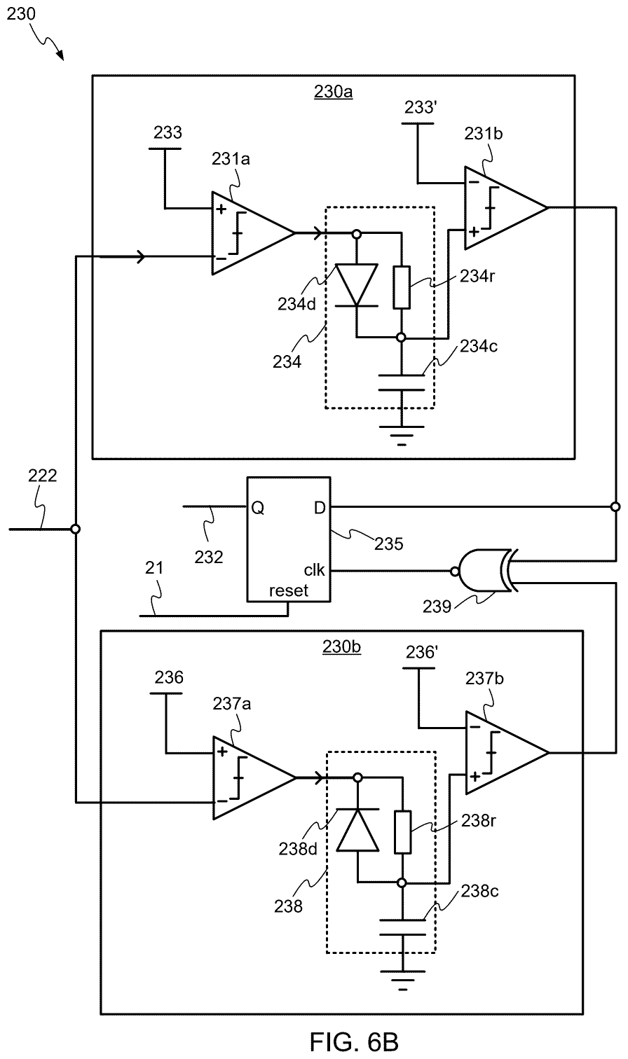

In FIG. 6A, exemplary time signal plots of the control signal 232 (lower graph) and the current data 222 (upper graph) are shown in reference to an aligned a common time axis t. As seen in the upper graph, at a first point in time T1, the current data 222 indicate a value of the load current i₁₂ exceeding the first predetermined threshold 233. However, as seen in the lower graph of FIG. 6A, the control signal 232 remains at an active or high state indicated by ‘1’ in FIG. 4A. At a second point in time T2, the current data 222 has indicated values of the load current i₁₂ exceeding the first predetermined threshold 233 for the first predetermined time T₂₃₃. At the second point in time T2, the control signal 232 toggles to an inactive or low state indicated by ‘0’ in FIG. 6A, i.e. breaks the current path between the battery cell 110 and the load 12. At a third point in time T3, the current data 222 indicate a value of the load current i₁₂ being below the second predetermined threshold 236. However, as seen in the lower graph of FIG. 6A, the control signal 232 remains at an inactive state (low or ‘0’). At a fourth point in time T4, the current data 222 has indicated values of the load current i₁₂ being below the second predetermined threshold 236 for a duration of the second predetermined time T₂₃₆. It is not until the fourth point in time T4 that the control signal 232 toggles to an active sate (high or ‘1’), i.e. closes the current path between the battery cell 110 and the load 12.

The behavior described in reference to FIG. 6A may be seen as a combination of the behaviors described in reference to FIG. 4A and FIG. 5A. As a result control circuitry 230 comprising first partial control circuitry 230a identical to the control circuitry of FIG. 4B and second partial control circuitry 230b identical to control circuitry of FIG. 5B is shown in FIG. 6B. The outputs of the first partial control circuitry 230a and second partial control circuitry 230b, i.e. outputs of the respective second comparator circuitry 231b, 237b, are connected to inputs of exclusive-not-or (XNOR) circuitry 239. The control signal 232 is provided at an output a flip-flop 235 clocked by an output of the XNOR circuitry 239. The first partial control circuitry 230a will generate a low (‘0’) output in response to the load current i₁₂ having exceeded the first predetermined threshold 233 for the first predetermined time T₂₃₃ and a will generate a high (‘1’) output substantially synchronously to the load current i₁₂ being below the first predetermined threshold 233. The second partial control circuitry 230b will generate a high (‘1’) output in response to the load current i₁₂ having been below the second predetermined threshold 236 for the second predetermined time T₂₃₆ and a will generate a low (‘0’) output substantially synchronously to the load current i₁₂ exceeding the second predetermined threshold 236. The XNOR circuitry 239 will generate a high (‘1’) output in response to the outputs of the respective partial control circuitry 230a, 230b being equal. The flip-flop 235 is assumed to be positive edge triggered, i.e. when a rising edge (or positive edge) is presented at a clock input “clk” of the flip-flop 235, the flip-flop 235 transfer a logic value present at a data input “D” of the flip-flop 235 to an output “Q” of the flip-flop 235. As mentioned, the output of the XNOR circuitry 239 is connected to the clock input “clk” of the flip-flop 235 which means that, in response to the XNOR circuitry 239 transitioning to high state (‘1’), i.e. the respective outputs from the partial control circuitry 230a, 230b are equal, a signal at the data input “D” of the flip-flop 235 will be provided at the output “Q” of the flip-flop 235, i.e. the control signal 232. In FIG. 6B, the data input “D” of the flip-flop 235 is connected to the output of the first partial control circuitry 230a. However, as the flip-flip 235 is triggered in response to the outputs of both the first partial control circuitry 230a and the second partial control circuitry 230b being equal, the data input “D” of the flip-flop 235 may, alternatively, be connected to the output of the second partial control circuitry 230b.

In the example of FIG. 6A, the first predetermined threshold 233 is greater than the second predetermined threshold 236. This is one example, and in other examples, the first predetermined threshold 233 is equal to the second predetermined threshold 236. The example presented in FIG. 6B is compatible with both scenarios, i.e. the first predetermined threshold 233 being greater than the second predetermined threshold 236, or the first predetermined threshold 233 being equal to the second predetermined threshold 236.

The control circuitry 230 may be configured to receive a reset signal 21 and to close the electrical connection between the battery cell 210 and the load 12 in response to the reset signal 21. The reset signal 21 may, as indicated in FIG. 6B, be connected to a reset input “reset” of the flip-flop 235. The flip-flop 235 is configured to generate a high (‘1’) signal at the output “Q” of the flip-flop 235 in response to the reset signal 21. The reset signal 21 may very well be implemented in any other example presented herein and is not limited to the example of FIG. 6B.

The exemplary control circuitry 230 presented with reference to FIG. 4B, FIG. 5B and FIG. 6B are configured to open or closed the current path between the battery cell 110 and the load 12. Correspondingly, rather than strictly opening or closing the current path between the battery cell 110 and the load 12, the control circuitry 230 may be configured to limit the load current i₁₂. The control circuitry 230 may be configured to limit the load current i₁₂ by pulse width modulation (PWM) of the transistor device 210 or controlling an on-resistance of the transistor device 210, i.c. partly opening or closing the transistor device 210 (linear control of the transistor device 210). By limiting the load current i₁₂ rather than disconnecting the battery cell 110 from the load 12, operation of the load 12 may be maintained but at a reduced load current i₁₂. If, for instance, the load 12 is an electrical propulsion source of a vehicle 10, the vehicle 10 may still be operational, but with a limited torque from the electrical propulsion source.

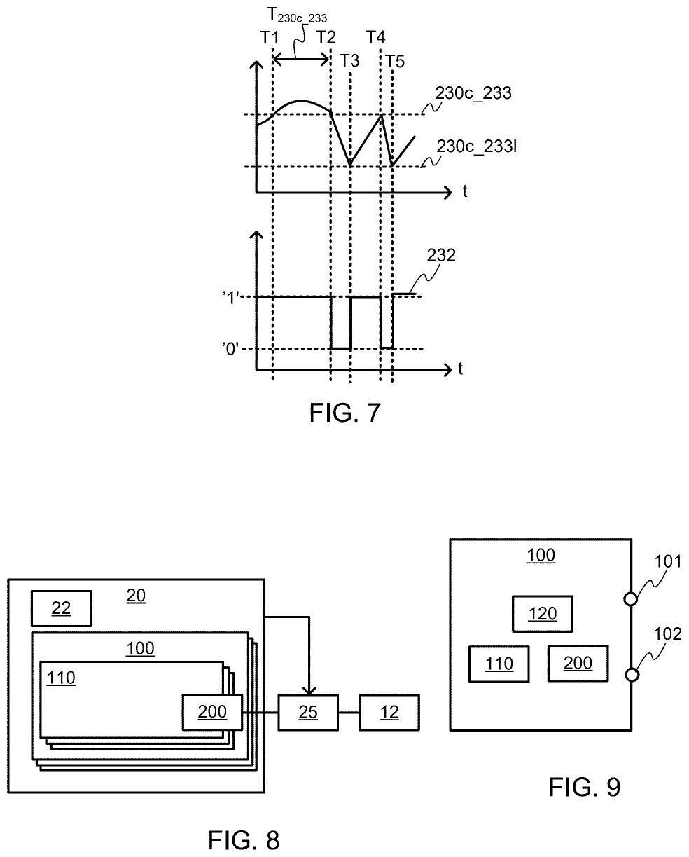

In FIG. 7, exemplary time signal plots of the control signal 232 (lower graph) and the current data 222 (upper graph) are shown in reference to an aligned a common time axis t. As seen in the upper graph, at a first point in time T1, the current data 222 indicate a value of the load current i₁₂ exceeding a third predetermined threshold 230c_233. However, as seen in the lower graph of FIG. 7, the control signal 232 remains at an active or high state indicated by ‘1’ in FIG. 7. At a second point in time T2, the current data 222 has indicated values of the load current i₁₂ exceeding the third predetermined threshold 230c_233 for a third predetermined time T230c_233. It is not until the second point in time T2 that the control signal 232 toggles to an inactive or low state indicated by ‘0’ in FIG. 7, i.e. breaks the current path between the battery cell 110 and the load 12. At a third point in time T3, the current data 222 indicate a value of the load current i₁₂ at or below a third predetermined lower threshold 230c_2331. At the third point in time T3, the control signal 232 toggles to an active state (‘1’) and closes the current path between the battery cell 110 and the load 12. The current data 222 indicate an increasing value of the load current i₁₂ and at a fourth point in time T4, the current data 222 indicate a value of the load current i₁₂ exceeding the third predetermined threshold 230c_233. At the fourth point in time T4, the control signal 232 once more toggles to an inactive state (‘0’) and breaks the current path between the battery cell 110 and the load 12. At a fifth point in time T5, the current data 222 once more indicate a value of the load current i₁₂ at or below a third predetermined lower threshold 230c_233l. At the fifth point in time T5, the control signal 232 toggles to an active state (‘1’) and closes the current path between the battery cell 110 and the load 12. The resulting control signal 232 may be described as a PWM signal.

Generally, if the load 12 comprises an electrical motor and associated control circuitry such as inverters etc., the load 12 will exhibit a substantial capacitance to a battery pack 100 and/or battery cells 110 connected to the load 12. If the capacitances of the load 12 are substantially discharged, the capacitances of the load 12 will cause a significant inrush current upon connection of the battery pack 100 to the load 12. To reduce a magnitude of the inrush current, the electrical current path between the battery pack 100 and/or battery cells 110 may be provided with a selectively connectable pre-charge circuitry. The pre-charge circuitry generally comprise at least one switch arranged to selectively connect a pre-charge resistor in a current path between the battery cells 110 and the load 12 or to bypass the pre-charge resistor. However, the pre-charge resistor is a comparably expensive component as it is required to dissipate significant amount of heat in order to keep a time for pre-charge short which means that pre-charge resistors are generally both large and expensive. However, as indicated with reference to e.g. FIG. 7, the resettable over current protection circuitry 200 of the present disclosure may be configured to control and limit the load current i₁₂. In other words, the resettable over current protection circuitry 200 and the control circuitry 230 may be configured to replace a pre-charge resistor between battery cells 110 and a load 12. The resettable over current protection circuitry 200 may consequently reduce a cost of a battery pack 100, a energy storage system 20 and/or a vehicle 10 depending on where a pre-charge resistor would have been arranged.

In FIG. 8 one example of a energy storage system 20 is shown. The energy storage system 20 of FIG. 8 is similar to the energy storage system 20 introduced with reference to FIG. 2 but comprise one or more battery packs 100. In other examples, not shown, the energy storage system 20 may comprise the electromechanical connector 25. Regardless of the specific example of the energy storage system 20 being referenced, the energy storage system 20, or rather the energy storage system processing circuitry 22, may be configured to control the resettable over current protection circuitry 200 to e.g. provide a pre-charge functionality, i.e. limit the load current i₁₂ by PWM or linear control of the transistor device 210.

The energy storage system 20, i.c. the energy storage system processing circuitry 22, may further be configured to cause control of the electromechanical connector 25. As mentioned, the electromechanical connector 25 is arranged to control an electrical connection between the load 12 and the battery pack 100. However, if a comparably large load current i₁₂ flows between the load 12 and the battery pack 100 upon actuation (opening) of the electromechanical connector 25, there is a significant risk of arcing and potentially welding of the electromechanical connector 25 due to an air gap being provided by at electromechanical connector 25 at a start of an opening operation and at an end of a closing operation. A risk of welding of the electromechanical connector 25 is particularly high in case of an inductive load 12 such an electric motor. The same issue arises upon closing the electromechanical connector 25 where inrush currents may cause welding of the electromechanical connector 25. It should be mentioned that welding is one extreme that may occur and that overvoltage (voltage spikes) and heating are other issues associated with operating the electromechanical connector 25 with a load current i₁₂ flowing. To reduce, mitigate and even solve this issue, the energy storage system 20 may be configured to control the current protection circuitry 200 to open the transistor device 210, i.e. break the current path between the battery pack 100 and the load 12 prior to causing opening or the electromechanical connector 25. Correspondingly, the energy storage system 20 may be configured to cause closing of the electromechanical connector 25 prior to causing control of the current protection circuitry 200 to close the transistor device 210, i.c. close the current path between the battery pack 100 and the load 12. This significantly reduces a wear of the costly electromechanical connector 25.

In FIG. 9, an exemplary battery pack 100 is shown. The battery pack 100 comprise one or more battery cells 110. The battery pack 100 may be configured with any feature or example presented herein. The battery pack 100 comprise one or more resettable over current protection circuitry 200 as presented herein. The battery pack 100 comprises a first terminal 101 and a second terminal 102 for connecting the battery pack 100 to the load 25 (optionally operatively via e.g. the electromechanical connector 25). The battery pack 100 may comprise optional battery pack processing circuitry 120. The battery pack processing circuitry 120 may be configured to control, configure, operate and/or monitor the resettable over current protection circuitry 200. The battery pack processing circuitry 120 may be configured to obtain operational data of the battery pack 100 and provide the operational data to e.g. the energy storage system 20. At least one over current protection circuitry 200 is provided in a current path between the one or more battery cells 110 and the first terminal 101 or the second terminal 102. In some examples, separate over current protection circuitry 200 may be arranged between each sets of battery cells and the first terminal 101 or the second terminal 102. In other words, a specific current protection circuitry 200 will only be arranged in a portion of the current path between the battery cells 110 and the first terminal 101 or the second terminal 102.

Example 1. A resettable over current protection circuitry 200 for an energy storage system 20 of a vehicle 10, the resettable over current protection circuitry 200 is configured to be arranged between one or more battery cells 110 and a load 12 and comprises: a transistor device 210 configured for controlling an electrical connection between the battery cell 110 and the load 12, current sensor circuitry 220 for measuring a load current i₁₂ between the one or more battery cells 110 and the load 12, control circuitry 230 configured to control the transistor device 210 to break the electrical connection between the one or more battery cells 110 and the load 12 responsive to the load current i₁₂ being above a first predetermined threshold 233 during a first predetermined time T₂₃₃.

Example 2. The resettable over current protection circuitry 200 of example 1, wherein the current sensor circuitry 220 comprises a comparator 231 configured to generate a control signal 232 configured to control the transistor device 210 to break the electrical connection between the one or more battery cells 110 and the load 12.

Example 3. The resettable over current protection circuitry 200 of example 1 or 2, wherein the control circuitry 230 is further configured to close the electrical connection between the one or more battery cells 110 and the load 12 responsive to the load current i₁₂ being below a predetermined second threshold 236 during a second predetermined time T₂₃₆.

Example 4. The resettable over current protection circuitry 200 of any one of examples 1 to 3, wherein the control circuitry 230 is configured to close the electrical connection between the one or more battery cells 110 and the load 12 responsive to receiving a reset signal 21.

Example 5. The resettable over current protection circuitry 200 of any one of examples 1 to 4, wherein the current sensor circuitry 220 comprises a known resistance arranged between the one or more battery cells 110 and the load 12, and the current sensor circuitry 220 is configured to measure the load current i₁₂ by measuring a voltage drop across the known resistance.

Example 6. The resettable over current protection circuitry 200 of example 5, wherein the known resistance is an on-resistance of the transistor device 210.

Example 7. The resettable over current protection circuitry 200 of any one of examples 1 to 6, wherein the first predetermined time T₂₃₃ is determined by a time constant of hardware components of the control circuitry 230.

Example 8. The resettable over current protection circuitry 200 of any one of examples 1 to 7, wherein the control circuitry 230 is configured to control the transistor device 210 to limit the electrical connection between the battery cell 110 and the load 12 responsive to the load current i₁₂ being above a third predetermined threshold 230c_233 during a third predetermined time T_{230c_233}.

Example 9. The resettable over current protection circuitry 200 of any one of examples 1 to 8, further comprising an internal power source 240 arranged to power the resettable over current protection circuitry 200.

Example 10. The resettable over current protection circuitry 200 of example 9, wherein the internal power source 240 is a rechargeable power source arranged to be charged from the battery cell 110.

Example 11. The resettable over current protection circuitry 200 of example 1, wherein the current sensor circuitry 220 comprises a comparator 231 configured to generate a control signal 232 configured to control the transistor device 210 to break the electrical connection between the one or more battery cells 110 and the load 12; the control circuitry 230 is further configured to close the electrical connection between the one or more battery cells 110 and the load 12 responsive to the load current i₁₂ being below a predetermined second threshold 236 during a second predetermined time T₂₃₆; the control circuitry 230 is configured to close the electrical connection between the one or more battery cells 110 and the load 12 responsive to receiving a reset signal 21; the current sensor circuitry 220 comprises a known resistance arranged between the one or more battery cells 110 and the load 12, and the current sensor circuitry 220 is configured to measure the load current i₁₂ by measuring a voltage drop across the known resistance; the known resistance is an on-resistance of the transistor device 210; the first predetermined time T₂₃₃ is determined by a time constant of hardware components of the control circuitry 230; the control circuitry 230 is configured to control the transistor device 210 to limit the electrical connection between the battery cell 110 and the load 12 responsive to the load current i₁₂ being above a third predetermined threshold 230c_233 during a third predetermined time T_{230c_233}; the internal power source 240 is a rechargeable power source arranged to be charged from the battery cell 110; and further comprising an internal power source 240 arranged to power the resettable over current protection circuitry 200.

Example 12. A battery pack 100 comprising one or more battery cells 110, at least two terminals 101, 102 for connecting the battery pack 100 to a load 12 and the resettable over current protection circuitry 200 of any one of examples 1 to 11 arranged in a current path of the one or more battery cells 110 and the at least two terminals 101, 102.

Example 13. The battery pack 100 of example 12, comprising two or more battery cells 110 wherein the resettable over current protection circuitry 200 is arranged in a portion of the current path of the one or more battery cells 110 and the at least two terminals 101, 102 located between the two or more battery cells 110.

Example 14. An energy storage system 20, comprising at least one battery pack 100 of example 12 or 13 and an energy storage processing circuitry 22 operatively connected to and configured to control the control circuitry 230 of the resettable over current protection circuitry 200 of the battery pack 100.

Example 15. The energy storage system 20 of example 14, wherein the energy

storage system processing circuitry 22 is configured to cause control of the transistor device 210 to provide a pre-charge current to the load 12.

Example 16. The energy storage system 20 of example 15, wherein the pre-charge current is provided by PWM control of the transistor device 210.

Example 17. The energy storage system 20 of example 15, wherein the pre-charge current is provided by linear control of the transistor device 210.

Example 18. The energy storage system 20 of any one of examples 13 to 17, wherein the energy storage system processing circuitry 22 is further configured to cause control at least one electromechanical connector 25 arranged to selectively connect the at least one battery pack 100 to the load 12.

Example 19. The energy storage system 20 of example 18, wherein the energy storage system processing circuitry 22 is configured to, prior to causing the electromechanical connector 25 to disconnect the at least one battery pack 100 from the load 12, control the transistor device 210 to break the electrical connection between the battery cell 110 and the load 12.

Example 20. The energy storage system 20 of example 18 or 19, wherein the energy storage system processing circuitry 22 is configured to, prior to causing the electromechanical connector 25 to connect the at least one battery pack 100 to the load 12, control the transistor device 210 to break the electrical connection between the battery cell 110 and the load 12.

Example 21. A vehicle 10 comprising the energy storage system 20 of any one of examples 14 to 20.

Example 22. The vehicle 10 of example 21, wherein the vehicle 10 is a heavy-duty or nautical vehicle.

Example 23. The vehicle of example 21 or 22, wherein the vehicle 10 is at least partly propelled by an electrical motor 12 powered by the battery pack 100 of any one of examples 12 or 13.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A resettable over current protection circuitry for an energy storage system of a vehicle, the resettable over current protection circuitry is configured to be arranged between one or more battery cells and a load and comprises:
a transistor device configured for controlling an electrical connection between the battery cell and the load,
current sensor circuitry for measuring a load current between the one or more battery cells and the load,
control circuitry configured to control the transistor device to break the electrical connection between the one or more battery cells and the load responsive to the load current being above a first predetermined threshold during a first predetermined time.

2. The resettable over current protection circuitry of claim 1, wherein the current sensor circuitry comprises a comparator configured to generate a control signal configured to control the transistor device to break the electrical connection between the one or more battery cells and the load.

3. The resettable over current protection circuitry of claim 1, wherein the control circuitry is further configured to close the electrical connection between the one or more battery cells and the load responsive to the load current being below a predetermined second threshold during a second predetermined time.

4. The resettable over current protection circuitry of claim 1, wherein the control circuitry is configured to close the electrical connection between the one or more battery cells and the load responsive to receiving a reset signal.

5. The resettable over current protection circuitry of claim 1, wherein the current sensor circuitry comprises a known resistance arranged between the one or more battery cells and the load, and the current sensor circuitry is configured to measure the load current by measuring a voltage drop across the known resistance.

6. The resettable over current protection circuitry of claim 5, wherein the known resistance is an on-resistance of the transistor device.

7. The resettable over current protection circuitry of claim 1, wherein the first predetermined time is determined by a time constant of hardware components of the control circuitry.

8. The resettable over current protection circuitry of claim 1, wherein the control circuitry is configured to control the transistor device to limit the electrical connection between the battery cell and the load responsive to the load current being above a third predetermined threshold during a third predetermined time.

9. The resettable over current protection circuitry of claim 1, further comprising an internal power source arranged to power the resettable over current protection circuitry.

10. The resettable over current protection circuitry of claim 9, wherein the internal power source is a rechargeable power source arranged to be charged from the battery cell.

11. The resettable over current protection circuitry of claim 1, wherein the current sensor circuitry comprises a comparator configured to generate a control signal configured to control the transistor device to break the electrical connection between the one or more battery cells and the load; the control circuitry is further configured to close the electrical connection between the one or more battery cells and the load responsive to the load current being below a predetermined second threshold during a second predetermined time; the control circuitry is configured to close the electrical connection between the one or more battery cells and the load responsive to receiving a reset signal; wherein the current sensor circuitry comprises a known resistance arranged between the one or more battery cells and the load, and the current sensor circuitry is configured to measure the load current by measuring a voltage drop across the known resistance; the known resistance is an on-resistance of the transistor device; the first predetermined time is determined by a time constant of hardware components of the control circuitry; the control circuitry is configured to control the transistor device to limit the electrical connection between the battery cell and the load responsive to the load current being above a third predetermined threshold during a third predetermined time; and further comprising an internal power source arranged to power the resettable over current protection circuitry wherein the internal power source is a rechargeable power source arranged to be charged from the battery cell.

12. A battery pack comprising one or more battery cells, at least two terminals for connecting the battery pack to a load and the resettable over current protection circuitry of claim 1 arranged in a current path of the one or more battery cells and the at least two terminals.

13. The battery pack of claim 12, comprising two or more battery cells wherein the resettable over current protection circuitry is arranged in a portion of the current path of the one or more battery cells and the at least two terminals located between the two or more battery cells.

14. An energy storage system, comprising at least one battery pack of claim 12 and an energy storage processing circuitry operatively connected to and configured to control the control circuitry of the resettable over current protection circuitry of the battery pack.

15. The energy storage system of claim 14, wherein the energy storage system processing circuitry is configured to cause control of the transistor device to provide a pre-charge current to the load.

16. The energy storage system of claim 15, wherein the pre-charge current is provided by PWM control of the transistor device.

17. The energy storage system of claim 15, wherein the pre-charge current is provided by linear control of the transistor device.

18. The energy storage system of claim 14, wherein the energy storage system processing circuitry is further configured to cause control of at least one electromechanical connector arranged to selectively connect the at least one battery pack to the load, and:
prior to causing the electromechanical connector to disconnect the at least one battery pack from the load, control the transistor device to break the electrical connection between the battery cell and the load and/or
wherein the energy storage system processing circuitry is configured to, prior to causing the electromechanical connector to connect the at least one battery pack to the load, control the transistor device to break the electrical connection between the battery cell and the load.

19. A vehicle comprising the energy storage system of claim 14.

20. The vehicle of claim 19, wherein the vehicle is at least partly propelled by an electrical motor powered by a battery pack.
